(19) United States
(12) Patent Application Publication
(10) Pub. No.: US 2020/0315094 A1
(43) Pub. Date: Oct. 8, 2020

(54) FOLDABLE EXTENDABLE HEAD FOR AGAVE HARVESTING

(71) Applicant: Rubén NAVARRO VELASCO, Guadalajara, Jalisco (MX)

(72) Inventor: Rubén NAVARRO VELASCO, Guadalajara, Jalisco (MX)

(21) Appl. No.: 16/305,756

(22) PCT Filed: Jun. 2, 2016
(86) PCT No.: PCT/MX2016/000056

§ 371 Date: Nov. 29, 2018

(30) Foreign Application Priority Data
May 30, 2016 (MX) MX/U/2016/000216

(51) Int. Cl. A01D 45/00

(52) U.S. Cl. CPC A01D 45/00

(57) ABSTRACT

This invention refers to an improved foldable and extensible head for agave harvest, characterized by including a vertical structure in whose lower end there is a support and fixation element of a lower-cut clamp, to cut the agave plant from its base, defined by a pair of straight-cut blades in a couple of curved clamps, completely opposing each other, each one fixed with its own rotating axis on the aforementioned support and fixation element. Each clamp includes a circular or semi-circular gear that allows the interlocking of both clamps and that together define a zipper mechanism to accurately synchronize the closing and opening movement between the clamps; a fixation structure of at least one hydraulic or pneumatic actuator is assembled in the rear area of the aforementioned support and fixation element, where the stem is pivotally fixed in the rear part, next to the rotating axis of at least one curved clamp to close or open both clamps as a result of the abovementioned zipper mechanism.

### FIELD OF THE INVENTION

This invention is connected with agriculture in general, and it is specifically related to the agricultural equipment, machines and implements that are assembled or coupled in tractors or other engine vehicles to perform harvesting activities. More specifically, it refers to the improvement in the foldable and extensible head for agave harvesting.

### BACKGROUND OF THE INVENTION

In the section of background of the invention of the patent request MX/a/2013/004605 made by the same inventor of the machine object of this patent, there is a thorough analysis of the harvesting of agave and of the techniques that are currently performed for the cutting thereof; patent (MX243917) referring to agave harvesting and cutting machines is also quoted; however, the abovementioned machine is a complex one that operates in such a way that a fork must go razor-close to the ground, making the agave plants pass through the horizontal arms with pointed ends, and in the joint end of the arms there are cutting blades; that is to say, it cuts by making pressure as the machine moves forward.

It requires a lower wear plate since the fork must move dragging over the soil. By cutting the agave plant at the base, it must be conducted through the transporter to carry the agave plant and deposit it in a cage-like barrel, which has blades that cut the leaves and stalks of the agave plant. It also entails an obstruction problem since the stalks or leaves cut must go out through the openings of the barrel that includes rings and leaves reduced slits that do not allow the correct exit of the agave stalks, which make the cutting difficult.

By conducting another search to determine the closest state of the art even further, document JP2007151438 “A” (document D1) was found, which reveals the agricultural implement 1 that has a machine body (2) connected to a vehicle that moves and the machine body (2) has a cutting means (4) to cut part of the stem and leaf (A1) of the beet (A), while spinning freely. The front end of the body or a spinning arm (15) is connected to the machine body (2) so that it can spin freely, and a frame body (21) connected to the rear end portion of the arm body (15) in turn, to spin freely.

A sliding guide body (23) in the remaining parts of the stem and leaves (A2) of the beet (A), is joined to the front part of the frame body (21). A cutting blade body (24) to cut part of the stem and remaining leaves (A2) of the beet (A), while it moves up and down to continue at the level of the beet (A), is joined to the rear part of the frame body (21).

In this case, document D1 shows a machine to mow part of the stem and leaves of the beet, which can be mounted, for example, on a tractor. It is formed by two main elements; the first one is where a cutting element (4) that is a horizontal rotating blade (4) mounted on a spinning tree (5) that cuts the highest part of the leaves of the beet (foliage part A1, FIG. 1) is mounted on a front area. It practically operates as a lawn mower and has the structure thereof.

The second element is a cutting assembly defined by a vertical frame structure (2) where the rotating arms are mounted (15, 17a) with a tensioning element (18), on which end a frame is fixed pivotally (21); the front of the frame body (21), which moves on the remaining foliage (A2) of the beet, comprises, for example, a sled body or similar to the guide body (23) for the sliding and adjusting of the vertical position.

The rear part of the frame body (21), and together with the frame body (21) and the guide body (23) together with the rotation of the rotating arm member (15), are configured and assembled with multiple components to be able to guide a straight-cutting blade (24) into angular position to mow all the projection of the ridges of the (ground surface).

It is evident that this agricultural implement does not operate nor is structured or configured to be able to make cuts from the end of the stalks of the agave.

Therefore, document D1 on its own does not disclose either the structural configuration or the elements, their assembly, manner of operation or triggering like the ones of the improved foldable extensible mowing head for the tips of the stalks of the agave plants; therefore, such document D1 does not affect the novelty of the invention whatsoever; in addition, the subject disclosed of the aforementioned document D1 does not enable a technician with average knowledge in the subject to, based on that disclosed information, infer and configure an improved foldable extensible mowing head for the tips of the stalks of the agave plants; therefore, the abovementioned document D1 does not affect the inventive activity either.

Document U.S. Pat. No. 1,315,3714 “A” (document D2) was also located, which discloses an agricultural equipment applied to the production of corn used for detasseling operations. More specifically, the invention is a cutting visual indicator that provides a built-in means of surveillance of the level of the cutters and tassel extractors in cutting machines for corn crops. The cutting visual meter ensures a uniform level of cutting operation in line with the optimal harvest demands of the plants.

The equipment includes a support structure that defines a vertical arm (142), where a first lower arm is fixed (152), which is extended by the effect of a main lifting cylinder (140), and where a sensor assembly bar is coupled (130), in which end there is a sensor (250) (electrical-optical sensor) to detect the level of the upper part of the plants; a second upper arm (150) extending in its end includes, connected pivotally to its end, a vertical bar of a cutting tool head (100) with a horizontal cutting blade (210), which is also fixed to the first lower arm (152) and to an actuator (120).

As can be seen in FIG. 6 of document D2, the tool is formed by an assembly which supports two arms; a sensor is mounted on one of them, and a vertical bar of a cutting head tool which includes a horizontal cutting blade is mounted on both of them. The sensor device detects the upper end of the plants (panicle) and the arms adjust the height of the cutting head tool so that the horizontal cutting blade cuts in an optimal zone.

However, the abovementioned document D2 does not disclose or suggest a foldable extensible mowing head for the tips of the stalks of the agave plants which is formed by a mechanism of two pairs of pincer clamps activated by hydraulic mechanisms which hug the agave plant and are closed to collect the stalks and cut the tips by the use of an upper clamp prepared with cutting blades; it does not reveal or disclose that the head comprises a hydraulic system and mechanism that adjusts, at different heights and closing diameter, the clamps system to cover the different sizes of the plants, nor does it include a hydraulic system with control levers or buttons and triggering by operator, to trigger the multiple actuators and mechanisms.

Consequently, document D2 on its own does not disclose either the structural configuration or the elements, their assembly, manner of operation or triggering like the ones of the improved foldable extensible mowing head for the tips of the stalks of the agave plants; therefore, such document D2 does not affect the novelty of the invention whatsoever; in addition, the subject disclosed in the aforementioned document D2 does not enable a technician with average knowledge in the field to, based on that disclosed information, infer and configure an improved foldable extensible mowing head for the tips of the stalks of the agave plants; in consequence, the abovementioned document D2 does not affect the inventive activity either.

Document JP2002300807 (document D3) was also located, which discloses a point mower that comprehends multiple spinning axes (2), each set with a spinning blade (3) placed on the body of the machine (1) configured in a perpendicular manner to the movement direction; the rotation axes are located in this manner, and the triggering axis for one engine (6) is installed at the center of the body of the machine and are linked between themselves using a round leash to allow the mechanical energy to be transmitted to all the rotating axes, and a frame of (7) including wheels (8) that are located at both end sides of the machine body to support it.

Notice this is a mowing machine that includes multiple rotating horizontal blades and that the support structure and the trigger are mounted on wheels.

The mowing machine of document D3 does not disclose or suggest a foldable extensible mowing head for the tips of the stalks of the agave plants, which is formed by a mechanism of two pairs of pincer clamps activated by hydraulic mechanisms which hug the agave plant and are closed to collect the stalks and cut the tips using an upper clamp prepared with cutting blades; it does not reveal or disclose that the head comprises a hydraulic system and mechanism that is adjusted at different heights and a closure diameter for the clamps system to cover the different sizes of the plants, nor does it include a hydraulic system with control levers or buttons and triggering (not shown) by operator, to trigger the multiple actuators and mechanisms.

Nor does it disclose that the two pairs of pincer clamps, the upper clamp and the lower clamp, incorporate straight sliding blades or opposing each other, each with its own axis and mounted on a gear rack drive mechanism of circular gears between axes and arms that coordinates in an accurate manner: the pressure, time, as well as the distance of the arms, being able to perform the work with one or several hydraulic cylinders, always maintaining the same precision, eliminating the risk of hydraulic leakage.

Therefore, document D3 on its own does not disclose either the structural configuration or the elements, their assembly, manner of operation or triggering like the ones of the improved foldable extensible mowing head for the tips of the stalks of the agave plants; therefore, such document D3 does not affect the novelty of the invention whatsoever; in addition, the subject disclosed in the aforementioned document D1 does not enable a technician with average knowledge in the subject to, based on that disclosed information, infer and configure an improved foldable extensible mowing head for the tips of the stalks of the agave plants; consequently, the abovementioned document D3 does not affect the inventive activity either.

Finally, document JP2001275449 (document D4) was located, which reveals and discloses a tobacco harvester formed by a column (95) [SIC] fixed in vertical position over the front part of a load platform (2) and mounted together with a vehicle to carry the harvester (4) for the purpose of regulating its height with the help of a handle (96). The vehicle to carry the harvester (4), in addition, is equipped with a transport unit (102) which spins vertically, an elastic element (51) [SIC] is placed between the load unit (102) and the vehicle (4), and the transport unit (102) is designed to allow the regulation of its angle by the help of the movement of the elastic element (51).

Document D4 reveals a tobacco harvester, configured with a very complex system and mechanisms to cut the tobacco plants from the base, invert them and hang them. It is very similar to the harvesters known as combined harvesters.

The machine in document D4, with its structural configuration, its elements and its interconnection, the manner of operation, could not mow the tips of the agave plants. Document D4 does not disclose or suggest a foldable extensible mowing head for the tips of the stalks of the agave plants, which is formed by a mechanism of two pairs of pincer clamps activated by hydraulic mechanisms which hug the agave plant and are closed to collect the stalks and cut the tips by the use of an upper clamp prepared with cutting blades; it does not reveal or disclose that the head comprises a hydraulic system and mechanism that adjusts at different heights and closing diameter of the clamps system to cover the different sizes of the plants, nor does it include a hydraulic system with control levers or buttons and triggering (not shown) by operator, to trigger the multiple actuators and mechanisms.

Nor does it disclose that the two pairs of pincer clamps, the upper clamp and the lower clamp, incorporate straight sliding blades or opposing each other, each with its own axis and mounted on a gear rack drive mechanism of circular gears between axes and arms that coordinates in an accurate manner the pressure, time, as well as the distance of the arms, being able to perform the work with one or several hydraulic cylinders, always maintaining the same precision, eliminating the risk of hydraulic leakage.

Therefore, document D4 on its own does not disclose either the structural configuration or the elements, their assembly, manner of operation or triggering like the ones of the improved foldable extensible mowing head for the tips of the stalks of the agave plants; therefore, such document D4 does not affect the novelty of the invention whatsoever; in addition, the subject disclosed in the aforementioned document D4 does not enable a technician with average knowledge in the subject to, based on that disclosed information, infer and configure an improved foldable extensible mowing head for the tips of the stalks of the agave plants; consequently, the abovementioned document D4 does not affect the inventive activity either.

Regarding the request of patent MX/a/2013/004605 of the same inventor as this invention, and which has been taken as the basis to make improvements in the foldable and extensible head, the invention is described as a machine to cut the tips of the stalks of the agave plants and prepare them for their subsequent cutting, which is formed by a chassis that defines a substantially horizontal platform that subsequently comprises a structural frame as support for the subsequently projected arms where the support tires are fixed to the ground of the aforementioned chassis and comprises, on the front end, a structural frame with arms projected towards the front to which a drawbar is attached, which is fixed to a tractor or other vehicle and an arm that is connected to the power socket of the tractor is fixed in the high part of the aforementioned structural frame. A support base that slides thanks to the action of the hydraulic elements mounted on a pair of parallel rails, which is placed transversally over said platform and is adapted to receive transport means, and the fixation of a foldable extensible mowing head for the tips of the stalks of the agave plants, which comprises a mechanism of pincer clamps activated by hydraulic mechanisms to hug the agave plant that are closed to collect the stalks and cut the tips by the use of an upper clamp prepared with cutting blades; such head comprises a hydraulic system and mechanism that adjusts, at different heights and closing diameter, the clamps system to cover the different sizes of the plants; the machine includes a hydraulic system with control levers or buttons and triggering by operator, to trigger the multiple actuators and mechanisms.

In the aforementioned patent request, the opening and closing of the clamps and blades was made by a dividing valve that should divide the hydraulic flux by 50% for each piston of each clamp or blade arm; as the valves proved not to be 100% accurate, since if one arm received more opposition than the other one, the arm receiving more opposition froze and the arm that had less opposition moved forward. Therefore, the offset of the movements affects the efficiency, thus braking the seals in the dividing valve. For that reason, in the improvements of this invention, a circular gear rack drive mechanism between axes and arms that accurately coordinates the pressure, time and distance between the arms was developed, which allows the work with one or several hydraulic cylinders, always keeping the same precision, eliminating the risk of hydraulic leakages.

The clamps that hug the stalks horizontally to close and compact the agave/maguey for the upper blade to make the horizontal cut (“banqueo” in Spanish). These two pairs of clamps, since they have their spinning axes overlapped, occupied a lot of space in that axis, so that in this invention a narrower clamp has been inserted inside another wider one; the clamps were also modified so that they are kept parallel while they are crisscrossing, thus achieving a firmer grip, without torsion of the bundle and in a more controlled manner. This system occupies less space in the vertical axis (Z) and provides a wider range of movement and adjustments to cover a great variety of sizes of agaves and mangueys.

The technification of the agricultural sector makes it necessary to develop and innovate new machinery and equipment, and a refinement thereof that allows to solve significant technical problems within the area, which, in turn, is translated into greater return and, above all, into greater agricultural productivity and production in the industry that takes advantage of agricultural products. In view of this situation, the improvement of the foldable and extensible head for the cutting of the tips of the agave stalks to prepare them for their subsequent cutting was developed.

### PURPOSES OF THE INVENTION

The main purpose of this invention is to make available an improved foldable and extensible head for the harvesting of agave which allows the reduction of work, risk and time in the harvesting of agave/maguey and which allows the provision of technology in this area in the agriculture field.

Another purpose of the invention is to provide the abovementioned improved foldable and extensible head for the harvest of agave, that is also more compact, of simple structure, practical and functional.

Another purpose of the invention is to provide the abovementioned improved foldable and extensible head for the harvest of agave, that can also be operated easily by an operator.

Another purpose of the invention is to provide the abovementioned improved foldable and extensible head for the harvest of agave, that is also structurally fit, safe and efficient, and which can be assembled and disassembled easily on a tractor.

Another purpose of the invention is to provide the abovementioned improved foldable and extensible head for the harvest of agave, which can also significantly reduce the production costs and which allows the increase of production and productivity in the harvesting of the aforementioned crop, by employing this technology.

Another purpose of the invention is to provide the abovementioned improved foldable and extensible head for the harvest of agave, that can also encompass means to adjust the height of the cutting elements depending on the height of the plants and the conditions of the land.

Another purpose of the invention is to provide the abovementioned improved foldable and extensible head for the harvest of agave, which, in addition, can reduce the work of the laborer, since he/she carries out the most difficult part of the cutting process, and for the producer to be able to reduce the times and costs of the harvest.

Another purpose of the invention is to provide the abovementioned improved foldable and extensible head for the harvest of agave, which can also be of easy manufacture and of relatively affordable cost for the agricultural producers.

Another purpose of the invention is to provide the abovementioned improved foldable and extensible head for the harvest of agave that is also compact, of smaller dimensions, less heavy, and requires less space, and, at the same time, offers a greater range of movement, maneuver and adjustment to cover the great variety of sizes of agave.

And all those qualities and purposes that will be made apparent when making a general and detailed description of this invention, based on the depicted embodiments.

### BRIEF DESCRIPTION OF THE INVENTION

In general, the improved foldable and extensible head for the harvest of agave, pursuant to this invention, includes a vertical structure in whose lower end there is a support and fixation element of a lower cutting clamp to cut agave plants from the base, and that is defined by a pair of straight-cutting blades fixed in a pair of curved clamps, opposing each other, each of them fixed with their own rotating axis in the aforementioned support and fixation element; and each clamp includes a circular or semi-circular gear that allows the interlocking of both clamps and that jointly define a zipper mechanism to accurately synchronize the closing and opening movement, the closing pressure, the triggering time, as well as the distance between the clamps; a fixation structure of at least one hydraulic or pneumatic actuator is assembled on the rear area of the aforementioned support and fixation element, where the stem is fixated pivotally in the rear area next to the rotation axis of at least one curved clamp, to close or open both clamps as a result of the aforementioned zipper mechanism.

In the preferred embodiment, two hydraulic or pneumatic actuators are required, one for each plier of such lower cutting clamp, to offer more closing strength of both clamps with more precision so as to ease the cut of the agave plant.

In the preferred embodiment, each curved clamp defines a beveled internal surface and, close to its inner border, there is a plurality of fixation means of the aforementioned straight cut blades, defined by a semi-circular body which has the blade on the straight inner border.

In one of the embodiments of the invention, the abovementioned vertical structure comprises in its front face a pair of vertical parallel sliding skates fitted to mount in a sliding manner, at least one mechanism of grabbing clamps defined by a sliding support and fixation element, built-in a sliding manner, on the aforementioned parallel vertical skates, where a couple of grabbing clamps are fixed opposed to each other, each fixed with its own rotation axis, on the aforementioned support and fixation element, and each clamp including a circular or semi-circular gear that allows both clamps to interlock, and that jointly define a zipper mechanism to accurately synchronize the closing and opening movement, the closing pressure, the triggering time, as well as the distance between the clamps; a fixation structure of at least one hydraulic or pneumatic actuator is mounted on the rear area of the aforementioned support and fixation element, where the stem is fixated pivotally in the rear area next to the rotation axis of at least one curved clamp, to close or open both clamps as a result of the aforementioned zipper mechanism, to be able to close and compress the stalks of the agave plant into a bunch.

In one of the embodiments of the invention, the aforementioned improved foldable and extensible head for agave harvest includes lower cut pliers to cut the agave plant from the base as it has been described, and two or more clamps with the configuration and assembly of each clamp mechanism as it has been described before; such clamp mechanisms include a height adjustment system that allows each clamp mechanism to go up and down depending on the height of the agave plants.

In the previous embodiment, two pneumatic or hydraulic actuators are necessary, one for each clamp of each mechanism, to provide more closing strength to the clamps with greater closing pressure and to grab the agave plants more tightly.

In another of the embodiments of the invention, the aforementioned improved foldable and extensible head for agave harvest includes lower cut pliers to cut the agave plant from the base as it has been described; a mechanism of clamps with a configuration and assembly of each clamp mechanism, as it has been described before, to close and compress the stalks of the agave plants into a bundle; and upper cut pliers to cut the tip of the stalks of the agave (“banquear” in Spanish). The abovementioned upper cut pliers are configured like the lower cut pliers, where the support and fixation element of such upper cut pliers is mounted in a sliding manner on the aforementioned pair of vertical skates, which comprises height adjustment means depending on the height of the agave plants, by removing from them the dangerous apical spines.

Another one of the invention embodiments, in the upper end of the vertical structure of the improved foldable and extensible head for the harvest of agave, comprises an L-shaped support structure, adapted to fix the abovementioned head into a maneuver arm to be able to manage the head from a transport equipment.

The aforementioned improved foldable and extensible head for the harvest of agave comprehends a hydraulic/pneumatic system to move a mechanical arm upon which the above head is positioned and to adjust the head on the X, Y and Z axes, with a guide, either laser or light, as well as to adjust the height of the upper cutting pliers and at least one mentioned clamps mechanism depending on the height of the agave plants to be harvested, which is controlled from a control panel by an operator. This way, the head is positioned on the agave or magueys crop line which are the gaps between ditches (X axis) to their possible heights (Z axis), and finally the position of the head to the front and back (Y axis) without the tractor or vehicle where the aforementioned head is mounted displacing following the ditch in straight line until the end of it.

In the preferred embodiment of the invention, the abovementioned opposed clamps of each mechanism are defined by an arm with a first section of substantially curved shape, followed by a second end section of substantially straight shape, ending in pointed shape, and, preferably, each arm is defined by two boards stacked one over the other, joined by a board, either on their inner face or their outer face to define a greater contact surface of the pliers with the stalks of the agave plants.

To better understand the characteristics of the invention, drawings are attached to this description as an integral part hereof, for description purposes but also including, the following:

### BRIEF DESCRIPTION OF THE FIGURES

FIG. 1 shows a conventional perspective of the foldable and extensible head for the harvest of agave, in compliance with one of the embodiments of the invention.

FIG. 1a shows an enlargement of the fixation of the pair of curved clamps of the lower cut pliers, in the support and fixation element in compliance with the preferred embodiment of the invention, shown in FIG. 1.

FIG. 2 shows a conventional perspective of the foldable and extensible head for the harvest of agave, in compliance with the second embodiment of the invention, where a mechanism of clamps is incorporated.

FIG. 2a shows an enlargement of the fixation of the pair of clamps of the clamps mechanism in the support and fixation element, in compliance with the second preferred embodiment of the invention, shown in FIG. 2.

FIG. 3 shows a conventional perspective of the foldable and extensible head for the harvest of agave, in compliance with a third embodiment of the invention where two mechanisms of clamps are integrated.

FIG. 3a shows the enlargement of the fixation of the pair of clamps of the second clamps mechanism in the support and fixation element, in compliance with the third preferred embodiment of the invention, displayed in FIG. 3.

FIG. 4 shows a view in conventional perspective of the foldable and extensible head for the harvest of agave, in compliance with the fourth embodiment of the invention, where lower cut pliers, a clamps mechanism and upper cut pliers are incorporated.

FIG. 4a shows the enlargement of the fixation of the pair of curved clamps of the upper-cut pliers in the support and fixation element, in compliance with the fourth preferred embodiment of the invention, displayed in FIG. 4.

FIG. 5 shows a view in conventional perspective of the foldable and extensible head for the harvest of agave, in compliance with the fifth embodiment of the invention, where lower cut pliers, two clamps mechanisms and upper cut pliers are incorporated.

For a better understanding of the invention, some of the embodiments thereof shall be described in detail, depicted in the drawings that are attached to this description for illustrative purposes and other purposes.

### DETAILED DESCRIPTION OF THE INVENTION

The characteristic details of the improved foldable and extensible head for the harvest of agave are clearly shown in the following description and the drawings attached, using the same reference signs to indicate the same parts.

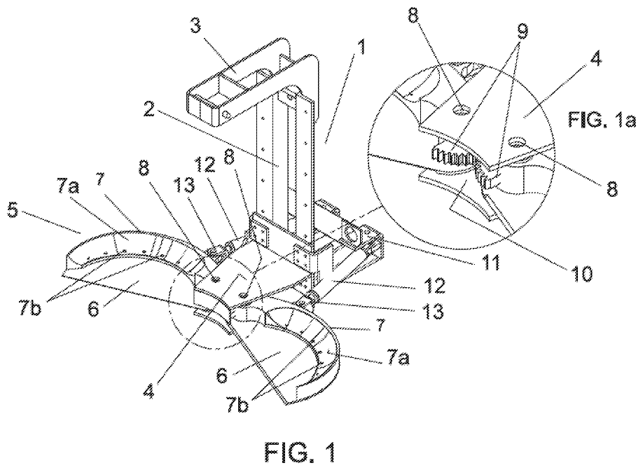

Making reference to FIGS. 1 and 1a, the improved foldable and extensible head (1) for the harvest of agave has a vertical structure (2) in whose upper end there is an L-shaped support structure (3), fitted to fix the aforementioned improved flexible and extensible head (1) in a maneuver arm (not displayed) to be able to manipulate it from a transport equipment (not displayed) and in whose lower end there is a support and fixation element (4) of lower cut pliers (5) to cut an agave plant from the base, that is defined by a pair of straight-cut blades (6) mounted on a pair of curved clamps (7) completely opposed between them, each of them fixed with their own rotating axis (8) in the abovementioned support and fixation element (4), and each clamp of the pair of curved clamps (7) includes a circular or semi-circular gear (9) that allows the interlocking of both clamps and that together define a zipper mechanism (10) to accurately synchronize the closing and opening movement, the closing pressure, and the triggering time as well as the distance between the curved clamps (7); a fixation structure (11) of the hydraulic actuators is mounted on the rear part of the aforementioned support and fixation element (4) of the lower-cut pliers (5) where the stem (13) is fixed pivotally to the rear part next to the rotating axis (8) of each pair of curved clamps (7) to close or open both clamps as a result of the abovementioned zipper mechanism (10).

Each curved clamp of the pair of curved clamps (7) defines an internal beveled surface (7a) and, close to its internal border, there are several fixation means (7b) of the aforementioned straight-cut blades (6), defined by a semi-circular body with the blade on the straight internal border.

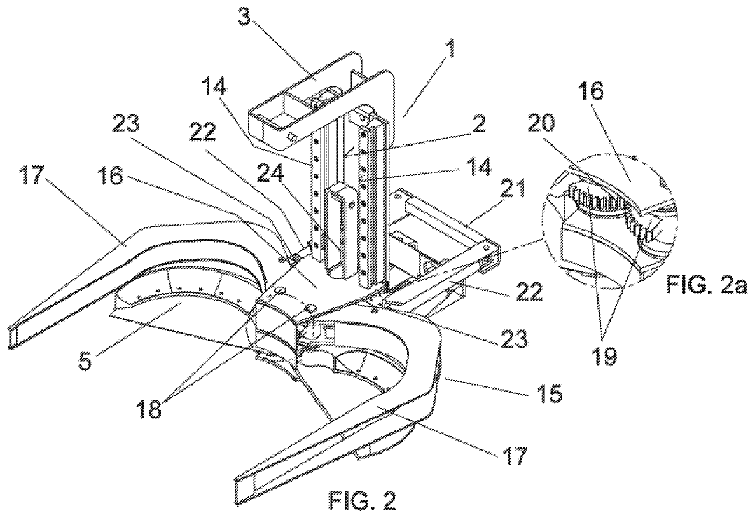

Regarding FIGS. 2 and 2a, the aforementioned improved foldable and extensible head (1) for the harvest of agave also includes the abovementioned lower-cut pliers (5) structured, configured and mounted as described in FIGS. 1 and 1a; in addition, it includes in its vertical structure (2) on its front face a pair of parallel vertical sliding skates (14) adapted to assemble, in a sliding manner, at least one clamp mechanism (15) defined by a sliding support and fixation mechanism (16) built-in in a sliding manner in the aforementioned vertical sliding skates (14) upon which a pair of clamps are fixed (17) opposed between them, each of them fixed with their own rotating axis (18) in the aforementioned sliding support and fixation element (16); and each clamp (17) includes a circular or semi-circular gear (19) that allows the interlocking of both clamps and that jointly define a zipper mechanism (10) to accurately synchronize the closing and opening movement, the closing pressure, and the triggering time, as well as the distance between the clamps (17); a fixation structure (21) of a pair of hydraulic or pneumatic actuators (22) is mounted on the rear area of the aforementioned sliding support and fixation element (16), where the stem (23) is fixated pivotally in the rear area next to the rotation axis (18) of the clamps, (17) to close or open both clamps as a result of the aforementioned zipper mechanism (20), and thus, be able to close and compress the agave plant into a bundle.

The aforementioned clamps mechanism (15) includes a system of height adjustment (24) that allows to move it up and down depending on the height of the agave plant.

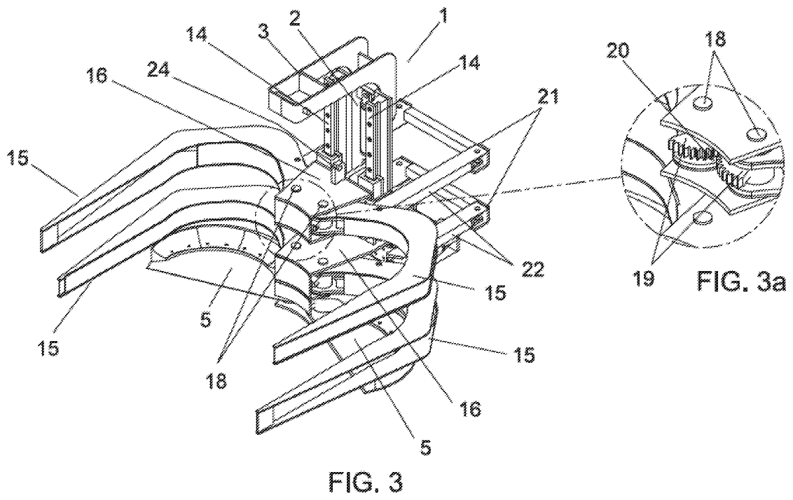

A embodiment of the foldable and extensible head (1) for the harvest of agave can be observed in FIGS. 3 and 3a, in compliance with a third embodiment of the invention where lower-cut pliers are incorporated (5) structured, configured and mounted as described above in FIGS. 1 and 1a, and two clamps mechanisms (15) structured, configured and mounted as described in FIGS. 2 and 2a, so that the same numeric references are used to signal the same parts.

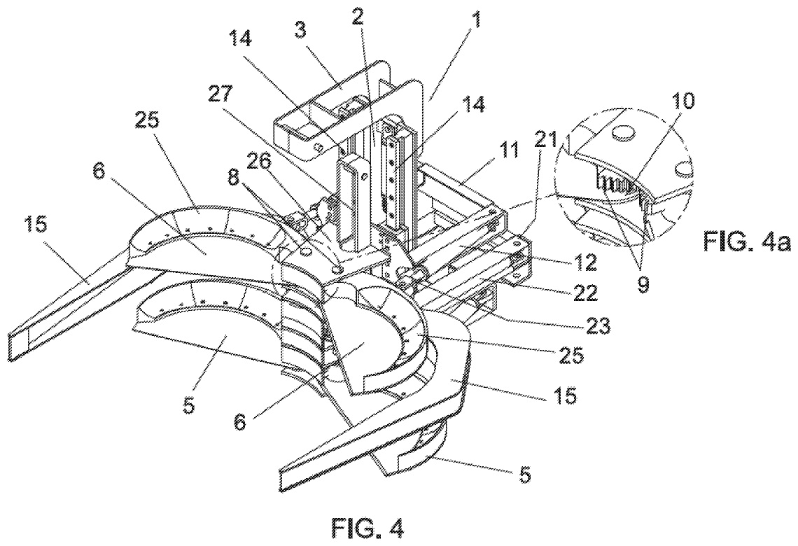

Regarding FIGS. 4 and 4a, the aforementioned improved foldable and extensible head (1) for the harvest of agave includes lower-cut pliers (5) structured, configured and mounted as described in FIGS. 1 and 1a; a clamp mechanism (15) structured, configured and mounted as described in FIGS. 2 and 2a, to which reference is made, and upper-cut pliers (25) to cut the tips of the stalks of the agave plants (“baquear” in Spanish), and said upper-cut pliers are set (25) in the same way as the lower-cut pliers (5), to which a support and fixation element (26) of the abovementioned upper-cut pliers (25) is mounted in a sliding manner, on the aforementioned vertical sliding skates (14) and including height adjustment means (27) depending on the height of the agave plants to cut the tips of the stalks of the abovementioned agave plants, removing the dangerous apical spines.

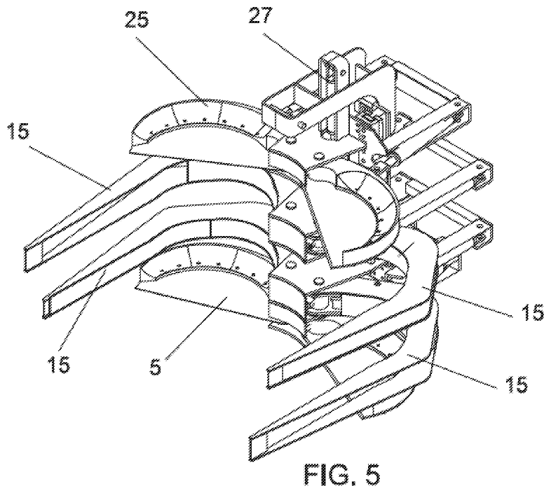

Regarding FIG. 5, the foldable and extensible head (1) for the harvest of agave, in compliance with a third embodiment of the invention where lower-cut pliers are incorporated, (5) structured, configured and mounted as described above in FIGS. 1 and 1a, and two clamps mechanisms (15) structured, configured and assembled as described in FIGS. 2 and 2a, and upper-cut pliers (25), structured, configured and assembled as described in FIGS. 4 and 4a, so that the same numeric references are used to signal the same parts.

The invention has been sufficiently described so that a person with average knowledge in the field may be able to reproduce and obtain the results mentioned in this invention. However, any person skilled in the art in the field of the applicable technology is able to make unwritten modifications in this request; nevertheless, if, for the application of these modifications in a specific structure or in the process of manufacture thereof, the field claimed in the following claims is required, such structures shall be included in the scope of the invention.

Having sufficiently described the invention, the content of the following claims is claimed as property:

1- the improved foldable and extensible head for agave harvest, in compliance with the above claims, characterized by including a vertical structure in whose lower end there are lower-cut pliers to cut the agave plant from the base (“banquear” in spanish), formed by a pair of straight-cut pliers in a pair of curved clamps completely opposing each other, each one fixed with its own rotating axis in the aforementioned support and fixation element; in addition, each clamp includes a circular or semi-circular gear that allows both clamps to interlock and to define together a zipper mechanism to accurately synchronize the closing and opening movement of the clamps; a fixation structure of at least one hydraulic or pneumatic actuator is mounted on the rear area of the aforementioned support and fixation element, where the stem is fixated pivotally in the rear area next to the rotation axis of at least one curved clamp, to close or open both clamps as a result of the aforementioned zipper mechanism.

2. The improved foldable and extensible head for agave harvest, in compliance with claim 1, characterized by including each clamp of each pair of lower-cut pliers that includes an actuator, to offer more closing strength of both clamps with higher pressure to facilitate the cutting of the agave plants.

3. The improved foldable and extensible head for agave harvest, in compliance with claim 1, characterized by a curved clamp that defines an internal beveled surface, and, close to its inner border, it has a variety of fixation means of the aforementioned straight-cut blades, defined by a semi-circular body, with the blade applied in its internal straight border.

4. The improved foldable and extensible head for agave harvest, in compliance with claim 1, characterized by the aforementioned vertical structure to also include in its front face a pair of sliding vertical skates, adapted to fit in a sliding manner, at least one clamp mechanism defined by a sliding support and fixation element on which a pair of clamps, opposed to each other, are fixed, and each clamp including a circular or semi-circular gear interlocked between them, defining a zipper mechanism to accurately synchronize the closing and opening movement of the abovementioned clamps; a fixation structure of at least one hydraulic or pneumatic actuator is assembled on the rear part of the above support and fixation element, where the stem is fixed pivotally in the rear part next to the rotating axis of at least one clamp to close and open both clamps as a result of the abovementioned zipper mechanism, and to be able to close and compress the stalks of the agave plant into a bundle.

5. The improved foldable and extensible head for agave harvest, in compliance with claim 4, characterized by each opposed clamp of each clamp mechanism, defined by an arm whose first section has a significantly curved shape, followed by a second external section which is substantially straight, ending in a pointed end; and where each arm is defined by two attached boards one over the other, joined through a board, either on the inner or outer face, to define a bigger contact surface of the clamps with the stalks of the agave plants.

6. The improved foldable and extensible head for agave harvest, in compliance with claim 4, characterized by the aforementioned clamp mechanism which includes a height adjustment system that allows each clamps mechanism to go up and down depending the height of the agave plants.

7. The improved foldable and extensible head for agave harvest, in compliance with claim 4, characterized because it also includes upper-cut pliers to cut the tip of the stalks of the agave plants (“banquear” in Spanish), formed by a pair of straight-cutting blades in a pair of completely opposed clamps one in front of the other, each one fixed with its own rotation axis in a sliding support and fixation element, mounted on each pair of vertical skates, and each clamp includes a circular or semi-circular gear interlocked between them, defining a zipper mechanism to synchronize in an accurate manner the closing and opening movement of the plants. A fixation structure of at least one hydraulic or pneumatic actuator, assembled in the rear part of the aforementioned support and fixation element where the stem is fixed pivotally in the rear area next to the rotating axis of at least one curved clamp, to close or open both clamps as a result of the abovementioned zipper mechanism.

8. The improved foldable and extensible head for agave harvest, in compliance with the above claims, characterized because said vertical structure of the improved foldable and extensive support to harvest agave includes, in its upper end, a support structure adapted to fix the aforementioned head into a maneuver arm, to be able to control the head from a transport equipment.

9. The improved foldable and extensible head for agave harvest, in compliance with the above claims, characterized by also including a mechanic/hydraulic mechanism to move a mechanical arm where the aforementioned head is mounted, and to adjust said head over the X, Y and Z axes with a guide, either laser or light, as well as to adjust the height of such pliers depending on the height of the agave plants to harvest, which is controlled from a control board by an operator.
